(19) United States
(12) Patent Application Publication
(10) Pub. No.: US 2010/0053070 A1
(43) Pub. Date: Mar. 4, 2010

(54) MULTI-DIMENSIONAL OPTICAL CONTROL DEVICE AND A CONTROLLING METHOD THEREOF

(75) Inventors: Meng-Che Tsai, Kaohsiung City (TW); Yung-Hsing Wang, Taichung City (TW); Po-Heng Lin, Hualien County (TW); Chia-Hsu Chen, Kaohsiung City (TW); Chi-Feng Chan, Chiayi County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/371,896

(22) Filed: Feb. 16, 2009

(30) Foreign Application Priority Data
Aug. 28, 2008 (TW) 97133001

(51) Int. Cl. G09G 5/00

(52) U.S. Cl. 345/156

(57) ABSTRACT

A multi-dimensional optical control device and a method thereof are provided. A movable light source can be moved due to an external action, and produce a light beam. A lens coupled to the light source is to focus the light beam. A sensor is used to sense a spot formed on the sensor by the focused light beam, and a data processing circuit coupled to the sensor is to obtain variations of position, shape and light intensity in respect to a reference spot. According to such variations of position, shape and light intensity, the data processing circuit performs a motion control of multiple dimensions

### CROSS-REFERENCE TO RELATED APPLICATION

This application claims the priority benefit of Taiwan application serial no. 97133001, filed Aug. 28, 2008. The entirety of the above-mentioned patent application is hereby incorporated by reference herein and made a part of specification.

### BACKGROUND OF THE INVENTION

1. Field of Invention

The present invention relates to optical control device. More particularly, the present invention relates to a multi-dimensional optical control device.

2. Description of Related Art

The control method applicable in the existing digital creation, industry design or related electronic products, such as: key board, mouse, touch pad type of plane control device is unable to attune to the needs of the user when a spatial six-dimensional control is required. Other control devices, such as button, key boards, etc. must be also be sued to complete the spatial six-dimensional control function. However, the additional control devices, not only increase the difficulty in the controlling process, the long-term operation of the additional control devices may lead to fatigue and even injury to the user. Moreover, replacing spatial control with sliding plane control is a nonhuman instinctive control method, which often leads to erroneous judgments or errors.

The U.S. Pat. No. 7,081,884 is directed to a computer input device, which is a three-dimensional input device for inputting, not only the translational displacement signal along the X and Y axis on a X-Y surface, also the angular displacement signal along the Z-axis. However, the device of the U.S. Pat. No. 7,081,884 must be applied on a highly reflective surface such that when a light source is illuminated on the surface, lights reflected from the surface is focused on an optical sensor system. By comparing the changes of the image, the displacement and rotational positions are thereby known. However, if the reflective property of the applied surface is less than desirable, it is unable for the optical sensing device to perform the sensing function. Further, a button mechanism must be provided for informing the system to sense the translational movement or angular movement of the image. Hence, the numbers of mechanical components and the structural volume of the device increase.

In the U.S. Pat. No. 5,694,153, two light sources at a fixed distance and a plate having holes are applied. Through the sensing of the displacements of the two light sources at a fixed distance by an optical sensor system and the application of the principle of trigonometric functions to complete a four-dimensional input control. As a six-dimensional input control is being demanded, it is necessary to provide one additional light source. Similarly, the principle of trigonometric functions is applied to complete the six-dimensional input control.

According to the teachings of the U.S. Pat. No. 6,333,733, a light source, a screen and an optical sensing unit are arranged in each of the three axial directions. Relying on the concurrent operations of the three light sources, the spatial control function is achieved. However, the invention of U.S. Pat. No. 6,333,733 requires multiple light sources, multiple screens and multiple optical sensing units.

The US 2006/0086889 A1 patent application teaches arranging six light sources, six slit plates and six optical sensing units in the space. Based on the operations of the six light sources, the spatial control function is achieved.

In the U.S. Pat. No. 6,480,183, a capacitive sensor is used to sense the movement of a set of conductive elements to achieve the plane shifting and rotational control functions. However, using the capacitive sensing method, the relative position between conductive elements and the sensing board is limited, and the spatial control function can not be directly performed.

In the U.S. Pat. No. 5,969,520, a plurality of magnetic devices senses the movement of a magnetic ball to achieve the plane control function. However, the relative positions between magnetic ball and the magnetic devices affect the sensing accuracy. Further, the magnetic devices are easily influenced by external magnetic objects to affect the determination of the position.

In the U.S. Pat. No. 6,774,886, the plane sliding control function is achieved through the contact between a conductor and a resistor. The junction between the conductor and the resistor, however, easily becomes humidified or oxidized, and a bad contact is resulted.

### SUMMARY OF THE INVENTION

The present invention provides a multi-dimensional optical control device that includes a movable light source, a lens, a sensor and a data processing circuit. The movable light source can be moved by external control and is used to generate a light beam. The lens is coupled to the movable light source and is used to focus the light beam. The sensor senses the light spot focused on the sensor. The data processing circuit is coupled to the sensor, and is used to obtain the position variation, the shape variation or the light intensity variation of the light spot on the sensor, wherein the position variation, the shape variation or the light intensity variation corresponds to the position, the shape or the light intensity of the reference light spot. Further, the data processing circuit outputs a control signal according to the position variation, the shape variation or light intensity variation to perform a rotational or translational multi-dimensional control movement.

The present invention also provides a multi-dimensional optical control device that includes a fixed or stationary light source, a lens, a movable reflective element, a sensor and a data processing circuit. The fixed light source is used to generate a light beam. The lens is coupled to the fixed light source and is used to focus the light beam. The movable reflective element can be moved by external control and is used to reflect the focused light beam through the lens. The sensor senses the light spot of the reflected light beam formed on the sensor. The data processing circuit is coupled to the sensor and is used to obtain the position variation, the shape variation or the light intensity variation of the light spot on the sensor, wherein the position variation, the shape variation or the light intensity variation corresponds to the position, the shape or the light intensity of the reference light spot. Further, the data processing circuit outputs a control signal according to the position variation, the shape variation or light intensity variation to perform a rotational or translational multi-dimensional control movement.

The present invention further provides a multi-dimensional optical control method, wherein a multi-dimensional movement control is performed according the changes of the light spot sensed by the sensor. The multi-dimensional optical control method includes at least the following process steps: setting an initial defining value of a reference light spot, wherein the initial defining value includes an initial center position, an initial light spot shape coverage and an initial unit area light intensity; determining whether a light spot shape coverage and an unit area light intensity of the light spot have changed after the light spot is moved; generating a control signal for executing a multi-dimensional movement control according to a light spot shape coverage variation and a light intensity variation.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram illustrating the structure of a multi-dimensional optical control device according to an embodiment of the present invention.

FIG. 1B is a schematic diagram illustrating the operation of a multi-dimensional optical control device according to an embodiment of the present invention.

FIGS. 2A, 2B, 2C are schematic diagram illustrating the configurations of the generated light spot, the pixel range of the reference light spot and the position of the reference light spot on the sensor.

FIG. 3 is a schematic diagram illustrating the coverage of light spot formed on the sensor element when the multi-dimensional optical control device is performing the movement operation along the horizontal plane (along the XY plane).

FIGS. 4A, 4B are schematic diagrams respectively illustrating the coverage of the light spot on the sensor formed by a horizontal plane rotation (rotation along the Z-axis) performed on the multi-dimensional optical control apparatus.

FIGS. 5A, 5B are schematic diagrams respectively illustrating the configuration of the multi-dimensional optical control device and the coverage of the light spot on the sensor formed by a horizontal plane rotation (rotation along the X-axis) performed on the multi-dimensional optical control apparatus.

FIGS. 6A, 6B are schematic diagrams respectively illustrating the configuration of the multi-dimensional optical control device and the coverage of the light spot on the sensor formed by a horizontal plane rotation (rotation along the Y-axis) performed on the multi-dimensional optical control apparatus.

FIG. 7 is a diagram showing the relationship between the unit area light intensity of the light spot and the rotational angle.

FIGS. 8A, 8B, 8C and 8D are schematic diagrams showing the multi-dimensional optical control device and the coverage of the formed light spot on the senor when the multi-dimensional optical control apparatus is performing a vertical up-down movement.

FIG. 9 is a flow chart of steps in exemplary processes that may be used in the method of controlling the multi-dimensional optical control device according to one embodiment of the present invention.

FIG. 10A is a schematic diagram of a multi-dimensional optical control device according to another embodiment of the present invention. FIGS. 10B, 10C, 10D are schematic diagrams of the plate in FIG. 10A.

FIG. 11A is a schematic diagram illustrating a multi-dimensional optical control device according to another embodiment of the present invention. FIGS. 11B and 11C are schematic diagrams of a plate in FIG. 11A.

FIG. 12A is a schematic diagram showing the packaging structure of the light source and the lens. FIG. 12B is a schematic diagram illustration the packaging structure of the light source, the plate and the lens.

FIGS. 13 and 14 are varying examples of the embodiments of the present invention.

### DESCRIPTION OF THE PREFERRED EMBODIMENTS

The fundamental idea of the present invention is to alter the position, the shape and the light intensity of the focused light spot of the light beam on the sensor in order to generate an appropriate control signal, wherein the light beam is generated from the internal light source during the operation of the optical control device. Based on the control signal, a corresponding movement or action is generated at the user end (for example, a monitor). The following embodiments serve to explain the principles of the invention.

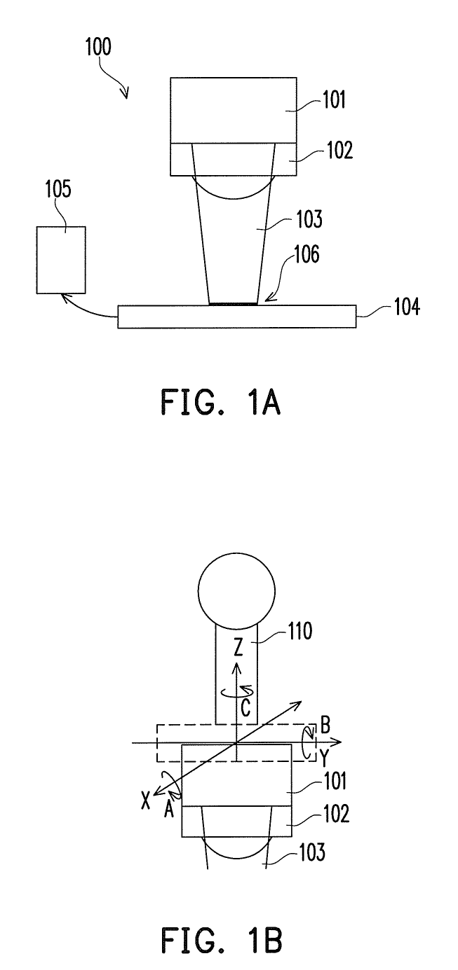

FIG. 1A is a schematic diagram illustrating the structure of a multi-dimensional optical control device according to an embodiment of the present invention. FIG. 1B is a schematic diagram illustrating the operation of a multi-dimensional optical control device according to an embodiment of the present invention. As shown in FIG. 1A, a multi-dimensional optical control device 100 includes a movable light source 101, a lens 102, a sensor 104 and a data processing circuit 105. The movable light source 101 can be moved by an external control and is used to generate a light beam 103. The lens 102 is coupled to the movable light source 101, allowing the light beam 103 to form cone shape and then to be focused on the sensor 104. The sensor 104 is used to sense the light spot 106 focused on the sensor 104. The data processing circuit 105 is coupled to the sensor 104 to obtain the position variation, the shape variation or the light intensity variation of the light spot 106 on the sensor 104. The position variation, the shape variation or the light intensity variation are referred to the position, the shape or the light intensity of the reference light spot, which will be further explained hereinafter. Moreover, the data processing circuit 105 calculates and outputs a control signal according to the above position variation, the shape variation or the light intensity variation. This control signal can be a digital signal or an analog signal. The control signal is sent to a host, for example, and the control signal is used to control the various movements or rotations of a target displayed on a monitor (screen).

As shown in FIG. 1B, in this embodiment, a six-dimensional optical control device is used to illustrate the principles of the present invention. However, depending on the type of application, modifications, alternatives, and equivalents as may fall within the spirit and scope of the invention. In an actual application, the movable light source 101 and the lens 102 of the six-dimensional optical control device are fixed on a movable mechanism 110, for example, connected to a control bar, wherein the control bar is mechanically connected to the movable light source 101 to form a joystick-like structure. Accordingly, by operating the joystick in a translational movement, a rotational movement or an up-down movement, the movable light source is moved correspondingly. The translational and the rotational movements will alter the position, the shape and the intensity of the light beam focused on the sensor 104, and the signal is sent to the data processing circuit 105.

The six-dimensional movements respectively include the horizontal movement, the vertical movement and the rotational movement. For example, the vertical distance between the top of the movable light source 101 and the sensor 104 is set as “D”, and a horizontal direction (X-axis, Y-axis) movement and the vertical direction (Z-axis) movement can be performed. A rotational movement using the X-axis as the rotational axis (A rotational axis) or using the Y-axis as the rotational axis (B rotational axis) or using the Z-axis as the rotational axis can also be performed. Hence, the rotational, horizontal and vertical movements together provide a six-dimensional movement.

Moreover, the above movable light source 101 can be a single wave length light source, for example, a light source formed by a laser diode. Further, the movable light source 101 can be a multiple wave length light source, for example, a light source from an incandescent lamp or a photodiode. Additionally, the above sensor can be a two-dimensional plane sensor, such as a photo diode array sensor, CMOS sensor or a CCD sensor.

In accordance to the motion theory of the embodiment of the present invention, a control signal is calculated based on the above-mentioned position variation, shape variation or light intensity variation.

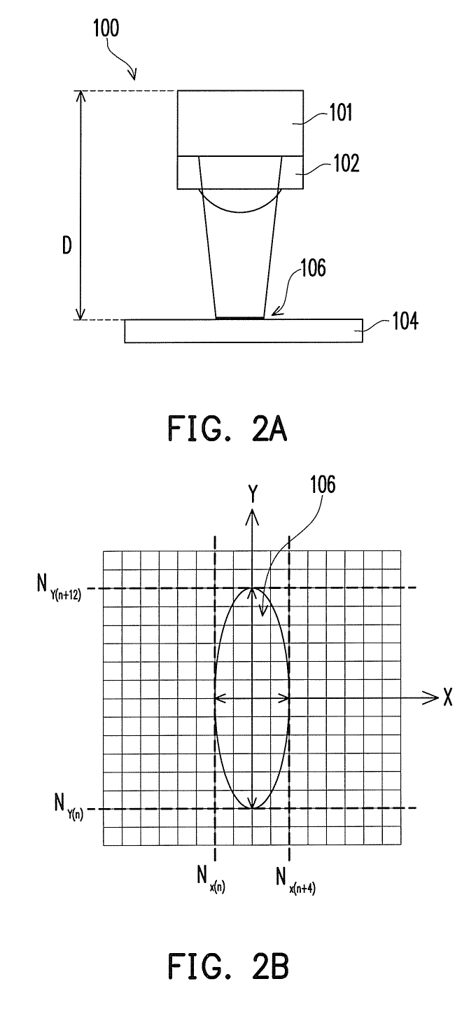

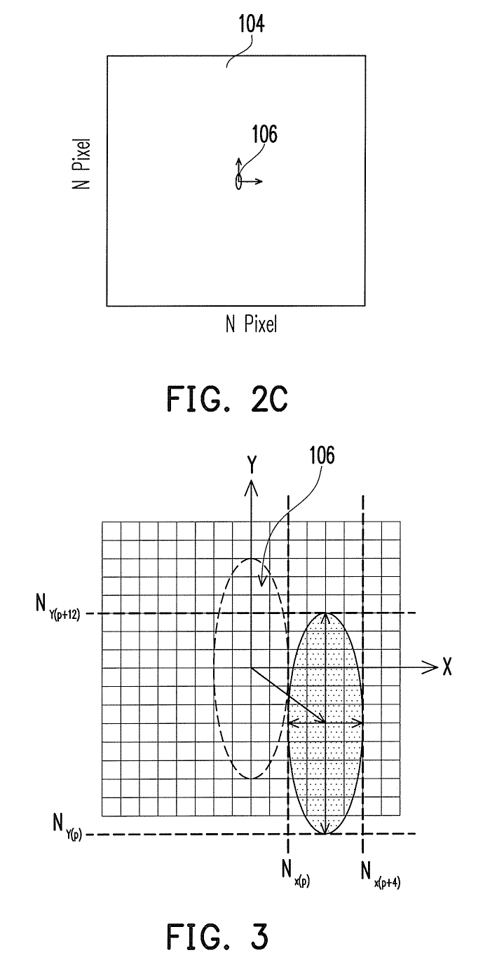

In order to ensure that the control signal can be obtained based on the position variation, the shape variation or the light intensity variation, there must be a datum serving as a reference standard, which is the above-mentioned reference light spot. FIGS. 2A, 2B, 2C are schematic diagrams illustrating the configuration of the generated light spot, the pixel range of the reference light spot, and the position of the reference light spot on the sensor.

In this embodiment of the invention, the reference light spot is defined as the light spot 106 generated from the movable light source 101 when the light source 101 remains stationary. In other words, when the multi-dimensional optical control device 100 is being operated externally and the vertical distance between the top of the movable light source 101 and the sensor 104 is set as “D”, the light beam 103, generated from the movable light source 101, passes through the lens 102 and focuses on the sensor 104 to generate the light spot 106 as shown in FIG. 2C. Further, the sensor 104 in this embodiment is, for example, a two-dimensional plane-type sensor having N×N pixels, and the center position of the sensor 104 surface is the same as the center position of the hypothetical reference light spot. The two center positions may also be different by one shift, and the appropriate calculation may be performed during the backend data processing. Moreover, the position of this reference light spot, which can also be referred as the initial position of the light spot, is distinguished from the position that has been moved and rotated.

Referring to FIG. 2B, under the reference light spot or the initial position of the reference light spot, the light beam 103 passes through the lens and focuses on the light sensor 104. The bounds occupied by the reference light spot 106 of the light beam 103 sensed by the light sensor 104: from the N_{X(n)} pixel to the N_{X(n+4)} pixel on the X-axis, and from the N_{Y(n)} pixel to the N_{Y(n+12)} pixel on the Y-axis. These ranges of the pixels are used herein simply for illustration purposes. Within the bounds of the light spot 106 sensed by the senor 104, the pixels on the senor element 104 can also sense one unit area light intensity I. Accordingly, the date processing circuit 105 can define an initial position of the reference light spot 106, a reference light spot shape coverage parameter and a unit area light intensity of the reference light spot sensed the senor element 104 as (X₀, Y₀, G₀, I₀). Further, (X₀, Y₀) is the center value of the pixel coverage formed by the light beam 103 on the sensor 104 (which is the center position of the light spot 106), and is represented by the following numerical expressions (1):

$${X}_{0} = \frac{{N}_{X ( n )} + {N}_{X ( n + 4 )}}{2} = {N}_{X ( n + 2 )} , \\ {Y}_{0} = \frac{{N}_{Y ( n )} + {N}_{Y ( n + 12 )}}{2} = {N}_{Y ( n + 6 )} \qquad ( 1 )$$

Moreover, the coverage parameter G₀ of the light spot shape is related to the bounds of the light spot 106 sensed by the sensor 104. More specifically, the coverage parameter G₀ the light spot shape is related to the pixels Nₓ and N_{y} covered by the light spot 106, and in general can be represented by the following numerical expressions (2):

G₀=[(N_{X(n+4)}−N_{X(n)}),(N_{Y(n+12)}−N_{Y(n)}]=[N_{X(4)}, N_{Y(12)})] (2)

Moreover, the unit area light intensity I₀ is related to the light intensity of the light beam 103 and the coverage of the light spot 106 sensed by the sensor 104. With the above-mentioned definitions, during the actual operation of the multi-dimensional optical control device, the data processing circuit can perform the calculation based on the above defined parameters of the reference light spot in combination with the light spot parameters sensed during the operation, and output a control signal of the corresponding control action.

FIG. 3 is a schematic diagram illustrating the coverage of the light spot formed on the sensor when the multi-dimensional optical control device is performing the movement operation along the horizontal plane (along the XY plane). As shown in FIG. 3, when the movable light source 101 and the lens 102, which are being externally operated, is moved with respect to the sensor 104 at the XY plane, and no rotation is performed using the X-axis as the rotation center or no rotation is performed using the Y-axis as the rotation center, or no vertical movement or rotation along the Z-axis, the light spot 106 of the light beam 103 sensed by the sensor 104 only proceeds in a translational movement on the sensing surface of the sensor 104. Further, the shape of the light spot remains unchanged, and the unit area light intensity also remains unchanged. Only the center position of the light spot 106 is shifted from the above-mentioned (X₀, Y₀) position.

As discussed above, the occupied pixel bounds on the senor 104 after the translation movement of the light spot ranges from the N_{X(p)} pixel to the N_{X(p+4)} pixel on the X-axis and ranges from the N_{Y(p)} pixel to the N_{Y(p+12)} pixel on the Y-axis, and the light spot shape coverage parameter Gₚ can be calculated using the following numerical expression (3).

Gₚ=[(N_{X(p+4)}−N_{X(p)}),(N_{Y(p+12)}−N_{Y(p)})]=[N_{X(4)}, N_{Y(}_{12)]} (3)

Apparently, Gₚ and the light spot initial value G₀ are identical. In other words, the shape of the light spot remains unchanged. Further, corresponding to the plane of the sensor 104, the movable light source 101 and the lens 102 are maintained on a same XY plane. Hence, the unit area light intensity of the light spot 106 sensed by the sensor 104 is I₀. Accordingly, under this condition, only the center position of the light spot 106 changes, from the initial position (X₀, Y₀) translational moved to the position (Xₚ, Yₚ), wherein the numerical expression for (Xₚ, Yₚ) is as shown below.

$${X}_{p} = \frac{{N}_{X ( p )} + {N}_{X ( p + 4 )}}{2} = {N}_{X ( p + 2 )} , \\ {Y}_{p} = \frac{{N}_{Y ( p )} + {N}_{Y ( p + 12 )}}{2} = {N}_{Y ( p + 6 )} . \qquad$$

Since the number and the position of the above N×N pixels on the sensor 104 are known, when the positions of movable light source 101 and the lens 102 are moved with respect to the sensor 104, the position of pixels of the sensor element 140 illuminated by the light beam 103 changes concurrently. Hence, the value of the center position of the light spot 106 generated by the light beam 103 changes from the initial value (X₀, Y₀) to (Xₚ, Yₚ).

Ultimately, the date processing circuit 105 calculates the variation in the light spot position defining value according to the data sent from the senor 104 and outputs a control signal of an XY plane movement to complete the function of an XY plane movement control.

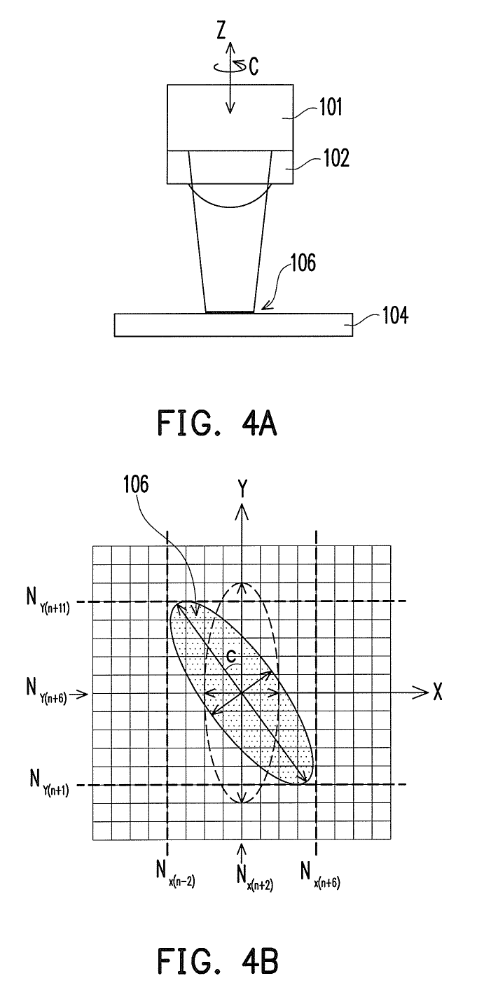

Thereafter, the rotation operation is discussed. Rotation can be divided into the Z-axis rotation, the X-axis rotation and the Y-axis rotation. The various rotational states are discussed hereinafter. FIGS. 4A, 4B are schematic diagram illustrating the coverage of the light spot formed on the sensor 104 when the multi-dimensional optical control apparatus is performing the rotation operation perpendicular to the horizontal plane (rotation along the Z axis).

As shown in FIG. 4A, when the movable light source 101 and the lens rotate with respect to the sensor element 104 on the XY plane; in other words, a rotation is performed with the Z-axis as the rotation center, and there is no rotational movement using the X-axis or the Y-axis as the rotation center and there is no vertical movement along the Z-axis, no horizontal movement along the X-axis or the Y-axis. In this situation, the center position defining value of the light spot 106 sensed by the sensor element 104 is represented by following numerical expression (4).

$$\begin{matrix}( {X}_{p} , {Y}_{p} ) = ( \frac{{N}_{X ( n - 2 )} + {N}_{X ( n + 6 )}}{2} , \frac{{N}_{Y ( n + 1 )} + {N}_{Y ( n + 11 )}}{2} ) \\ = ( {N}_{X ( n + 2 )} , {N}_{Y ( n + 6 )} ) \\ = ( {X}_{0} , {Y}_{0} )\end{matrix} \qquad ( 4 )$$

In other words, when rotating along the z-axis, the center of the light spot 106 remains unchanged which implies the center position of the light beam 103 focused on the sensor element 104 remains unchanged. However, the light spot shape coverage is rotated at an angle along the Z-axis, as shown in FIG. 4B. The light spot shape coverage parameter Gₚ is represented by the following numerical expression (5).

Gₚ=[(N_{X(n+6)}−N_{X(n-2)}),(N_{Y(n+11)}−N_{Y(n+1)})]=[N_{X(8)}, N_{Y(10)}] (5)

In this embodiment, with respect to the sensor 104, the movable light source 101 and the lens 102 are maintained on a same XY plane. Hence, the unit area light intensity I₀ of the light spot 106 detected by the sensor 104 still remains unchanged. Since the center position of the focused light spot of the light beam 103 and the defining value of the unit area light intensity remain unchanged, the data processing circuit 105 calculates the rotational angle of the light spot 106 on the XY plane based on the variance of the coverage by the light spot 106 sensed by the sensor 104, as shown in the following numerical expression (6)

$$c = {tan}^{- 1} ( \frac{{N}_{X ( n - 2 )} - {N}_{X ( n + 2 )}}{{N}_{Y ( n + 11 )} - {N}_{Y ( n + 6 )}} ) = {tan}^{- 1} ( \frac{{N}_{X ( - 4 )}}{{N}_{Y ( 5 )}} ) \qquad ( 6 )$$

wherein c is the rotational angle along the Z-axis. Based on the result, the data processing circuit 105 outputs one XY plane rotation signal to complete the XY plane rotation control, which is the rotation control function using the Z-axis as a center.

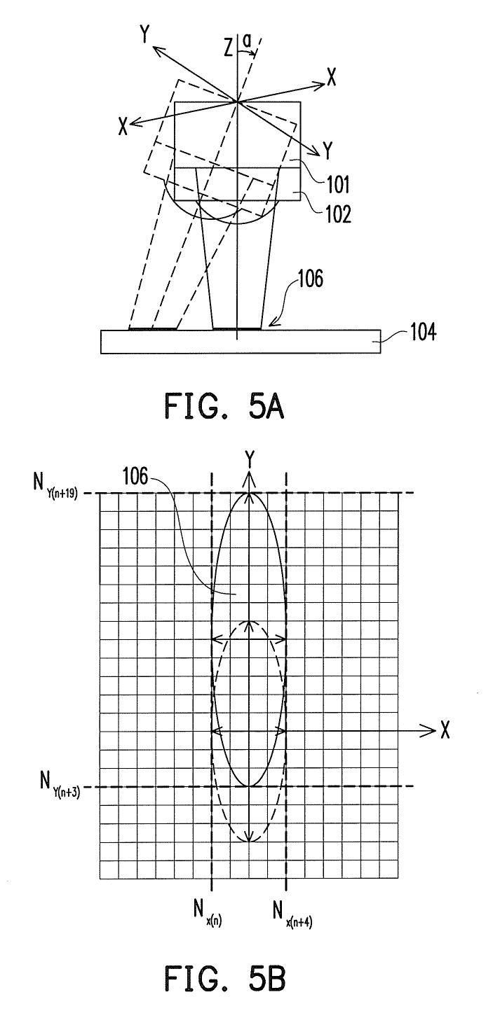

FIGS. 5A, 5B are a diagram illustrating the configuration of the multi-dimensional optical control device as the multi-dimensional optical control device is performing the horizontal plane rotation (rotate along the X-axis) and a schematic diagram of the coverage of the light spot formed on the sensor. As shown in FIGS. 5A, 5B, when the light source 101 and the lens 102 are rotating with respect to the sensor 104 at an angle “a” using the X-axis as the center of rotation, the light beam also illuminates on the sensor at an incident angle “a”. The coverage by the pattern of the light spot 106 of the focused light beam 103 sensed by the pixels on the sensor 104 and the coverage of the reference light spot at the X-axis direction remains unchanged, while the coverage in the Y-axis direction has changed, as shown in FIG. 5B. Accordingly, based on the previously discussed approach, the light pattern coverage parameter Gₐ of the light spot 106 has changed as indicated by the following numerical expression (7).

Gₐ=[(N_{X(n+4})−N_{X(n)}),(N_{Y(n+19)}−N_{Y(n+3)})]=[N_{X(4)},N_{Y(16)}] (7)

Moreover, the center position of the light spot 106 sensed by the pixels on the sensor 104 has also changed to the position (Xₐ,Yₐ), as represented by the following numerical expression (8):

$$\begin{matrix}( {X}_{a} , {Y}_{a} ) = ( \frac{{N}_{X ( n )} + {N}_{X ( n + 4 )}}{2} , \frac{{N}_{Y ( n + 3 )} + {N}_{Y ( n + 19 )}}{2} ) \\ = ( {N}_{X ( n + 2 )} , {N}_{Y ( n + 11 )} )\end{matrix} \qquad ( 8 )$$

Since the light beam 103 illuminates on the sensor 104 at an incident angle “a”, the unit area light intensity of the light spot 106 sensed by the pixels on the sensor 104 is weakened to Iₐ. Based on the changes in the defining values of the above light pattern coverage parameter Ga, the center position (Xₐ,Yₐ), and the unit area light intensity Iₐ, the data processing circuit 105 then relies on the following numerical expression (9) to calculate the rotation angle of the light source 101 and the lens 102 using the X-axis as the center of rotation.

$$a = {tan}^{- 1} ( \frac{\sqrt{{( {X}_{a} - {X}_{0} )}^{2} + {( {Y}_{a} - {Y}_{0} )}^{2}}}{D} ) \qquad ( 9 )$$

Accordingly, based on the light pattern coverage parameter Gₐ, the rotation angle “a” or “−a” can be determined. With this result, the data processing circuit 105 outputs a rotation signal using the X-axis as the center of rotation to complete the function of rotation control using the X-axis as the center of rotation.

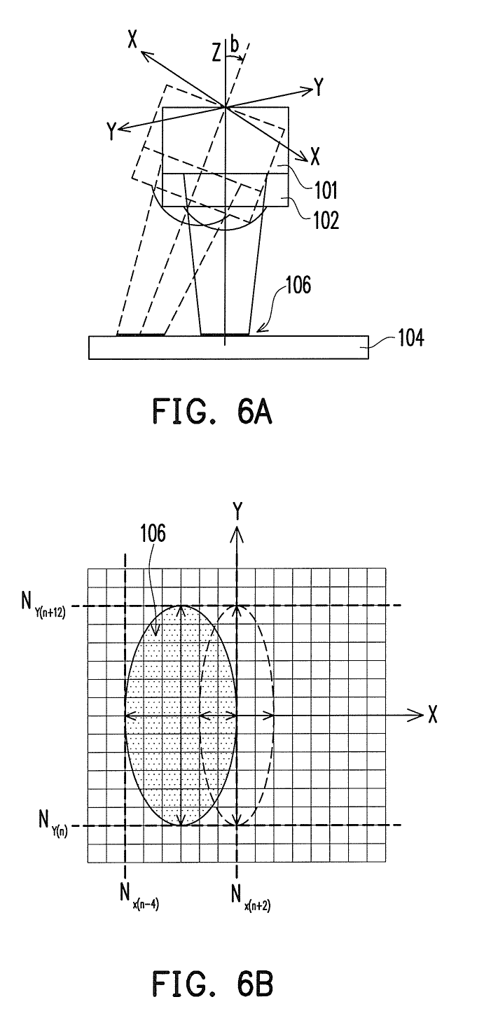

FIGS. 6A, 6B are a diagram of the configuration of the multi-dimensional optical control device as the multi-dimensional optical control device is performing the horizontal plane rotation (rotate along the Y-axis) and a schematic diagram of the coverage of the light spot formed on the sensor. As shown in FIGS. 6A, 6B, when the light source 101 and the lens 102 are rotating with respect to the sensor 104 at an angle “b” using the Y-axis as the center of rotation, the light beam also illuminates on the sensor at an incident angle “b”. The light pattern coverage of the light spot 106 sensed by the sensor 104 and the coverage of the reference light spot 106 at the Y-axis direction remains unchanged, while the coverage in the X-axis direction changes. Accordingly, the light pattern coverage parameter G_{b} of the light spot 106 changes, as represented by the following numerical expression (10).

G_{b}=[(N_{X(n+2)}−N_{X(n-4)}),(N_{Y(n+12)}−N_{Y(n)})]=[N_{X(16)}, N_{Y(12)}] (10)

Further, the center position of the light spot 106 sensed by the sensor 104 also changes, as represented by the following numerical expression (11).

$$\begin{matrix}( {X}_{b} , {Y}_{b} ) = ( \frac{{N}_{X ( n - 4 )} + {N}_{X ( n + 2 )}}{2} , \frac{{N}_{Y ( n )} + {N}_{Y ( n + 12 ) }}{2} ) \\ = ( {N}_{X ( n - 1 )} , {N}_{Y ( n + 6 )} )\end{matrix} \qquad ( 11 )$$

Since the light beam 103 illuminates on the sensor 104 at an incident angle “b”, the unit area light intensity of the light spot 106 detected by the pixels on the sensor is weakened to I_{b}. Based on the changes of the defining values of the above light pattern coverage parameter G_{b}, the center position (X_{b},Y_{b}), and the unit area light intensity Iₐ, the data processing circuit 105 can relies on the following numerical expression (12) to calculate the rotation angle of the light source 101 and the lens 102 using the Y-axis as the center of rotation.

$$b = {tan}^{- 1} ( \frac{\sqrt{{( {X}_{b} - {X}_{0} )}^{2} + {( {Y}_{b} - {Y}_{0} )}^{2}}}{D} ) \qquad ( 12 )$$

Moreover, the rotational direction can also be determined by the light pattern coverage parameter G_{b}. With this result, the data processing circuit 105 can output a rotation signal using the Y-axis as the center of rotation to complete the function of rotation control using the Y-axis as the center of rotation.

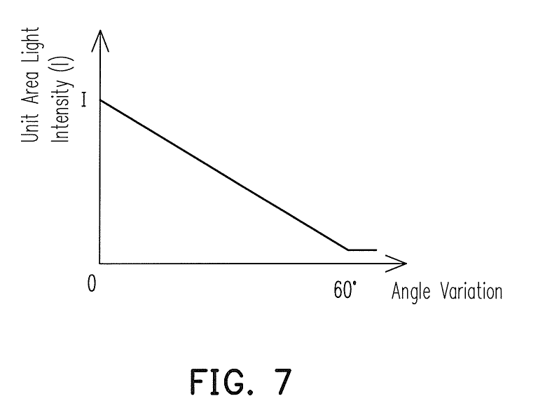

FIG. 7 is a diagram showing the relationship between the unit area light intensity of the light spot and the rotation angle. As shown in FIG. 7, when the light source 101 and the lens 102 are rotated with respect to the sensor 104 using the X-axis as the center of rotation or the Y-axis as the center of rotation, the higher the rotation angle, the weaker the unit area light intensity I of the light spot 106 is being detected by the sensor 104.

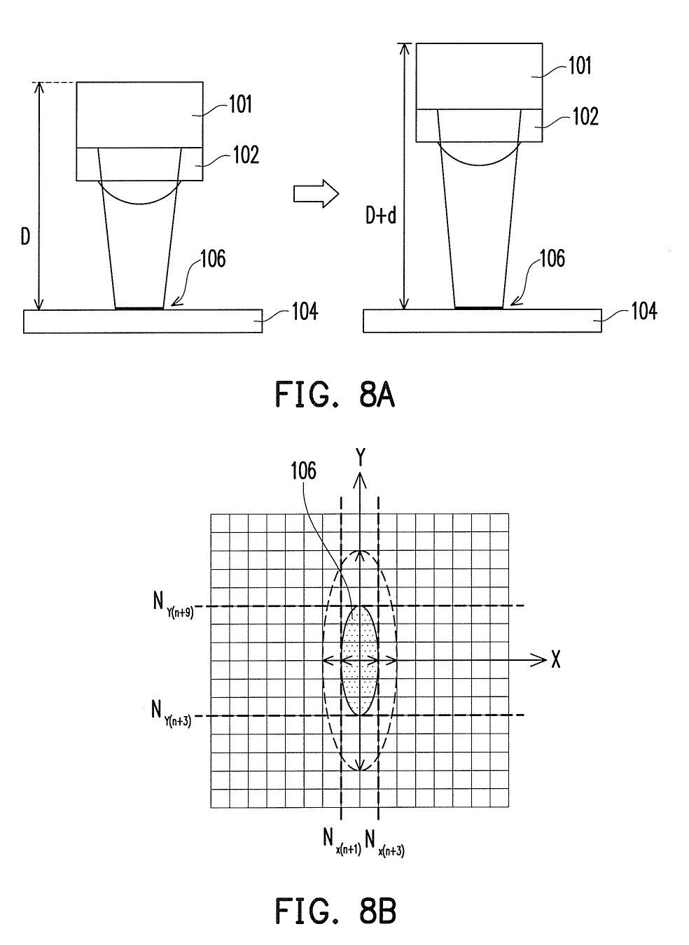

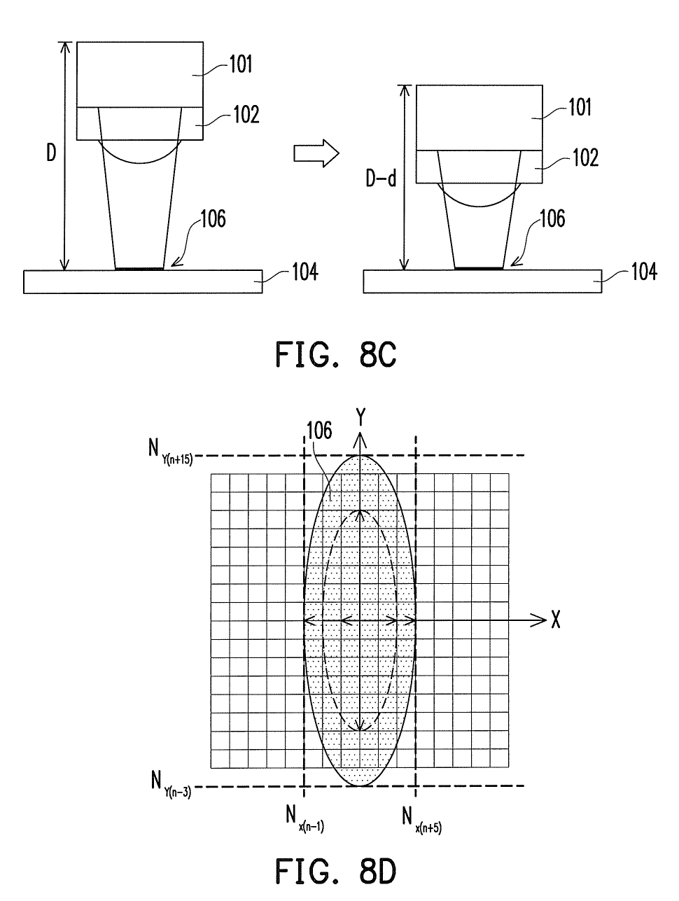

FIGS. 8A, 8B, 8C, 8D are diagrams illustrating the configuration of the multi-dimensional optical control device as the multi-dimensional optical control device is performing the up-down movement in the vertical direction (move up and down along the Z-axis) and the coverage of the light spot formed on the sensor. After the light beam travels from the movable light source 101 through the lens 102, the light forms a cone shape. When the distance between the sensor 104 and the movable light source 101 changes, the range of the light pattern coverage of the light spot 106 sensed by the pixels on the sensor 104 changes at a ratio along the X-axis and the Y-axis.

FIG. 8A is a diagram showing the situation when the multi-dimensional optical control device moves up along the Z-axis, while FIG. 8B is a diagram showing corresponding light pattern coverage of the light spot. As shown in FIG. 8A, 8B, when the distance between the top of the movable light source 101 and the sensor 104 is increased from D to D+d, the light source is moved up a distance “d” from the sensor 104 in the positive Z-axis direction. The defining value of the XY plane center position of the light spot 106 of the light beam focused on sensor 104 can be calculated using the following numerical expression (13).

$$\begin{matrix}( {X}_{p} , {Y}_{p} ) = ( \frac{{N}_{X ( n + 1 )} + {N}_{X ( n + 3 )}}{2} , \frac{{N}_{Y ( n + 3 )} + {N}_{Y ( n + 9 )}}{2} ) \\ = ( {N}_{X ( n + 2 )} , {N}_{Y ( n + 6 )} )\end{matrix} \qquad ( 13 )$$

It is apparent from the above numerical expression (13) that after the light source rises up a distance “d”, the light spot 106 and the previous reference light spot initial center position defining value (X0,Y0) are the same. However, the distribution range of the light pattern coverage parameter G_{+d} is reduced as represented by the following numerical expression.

G_{+d}=[(N_{X(n+3)}−N_{X(n+1)}),(N_{Y(n+9)}−N_{Y(n+3)})]=[N_{X(2)}, N_{Y(6)}] (14)

Under this situation, the unit area light intensity of the light spot 106 detected by the sensor 104 is increased to I_{+d}. This is because the area of the light spot 106 is reduced, and the light intensity of the unit area is increased.

FIG. 8C a diagram showing the situation of a downward movement along the Z-axis, while FIG. 8B is a diagram showing the corresponding light pattern coverage of the light spot. As shown in FIG. 8C, 8D, when the distance between the top of the movable light source 101 and the sensor 104 is decreased from D to D−d, the light source is moved down a distance “d” from the sensor 104 in the negative Z-axis direction. The defining value of the center position of the XY plane of the light spot 106 of the light beam focused on sensor 104 can be calculated using the following numerical expression (15).

$$\begin{matrix}( {X}_{p} , {Y}_{p} ) = ( \frac{{N}_{X ( n - 1 )} + {N}_{X ( n + 5 )}}{2} , \frac{{N}_{Y ( n - 3 )} + {N}_{Y ( n + 15 )}}{2} ) \\ = ( {N}_{X ( n + 2 )} , {N}_{Y ( n + 6 )} )\end{matrix} \qquad ( 15 )$$

It is apparent from the above numerical expression (16) that after the light source is lowered a distance “d”, the light spot 106 and the previous reference light spot initial center position defining value (X0,Y0) are the same. However, the distribution range of the light pattern coverage parameter G_{-d} is reduced as represented by the following numerical expression (16).

G_{-d}=[(N_{X(n+5)}−N_{X(n-)}),(N_{Y(n+15)}−N_{Y(n-3)})]=[N_{X(6)}, N_{Y(18)}] (16)

Under this situation, the unit area light intensity of the light spot 106 detected by the sensor 104 is increased to I_{-d}. This is because the area of the light spot 106 is increased, and the light intensity of the unit area is reduced.

In accordance to the above result, based on the relationship between the light pattern coverage ratio of the light beam 103 on the sensor 104 and the unit area light intensity I, the vertical distance between the movable light source 101 and the lens with respect to the senor 104 can be defined. The data processing circuit 105 then calculates the changes in the vertical distance between the movable light source 101 and the lens 102 with respect to the sensor based on the defined relationships and outputs one vertical direction displacement signal to complete the displacement control function in the vertical Z-axis direction.

In accordance to the above, the factors that affect the unit area light intensity of the light spot 106 include the distance between the light source and the sensor and the rotation angles along the X-axis and the Y-axis. Therefore, if the sensor detects a change in the unit area intensity, it can be deduced that the multi-dimensional optical control apparatus 100 is moving up and down along the Z-axis, or rotating along the X-axis or the Y-axis.

Moreover, according to the changes in the relationship between the light pattern center position sensed by the sensor and the initial center position, or whether the light pattern has rotated, it can be deduced that the multi-dimensional optical control device 100 is moving on the XY plane or rotating along the Z-axis, X-axis or Y-axis.

Accordingly, based on the signals received by the data processing circuit and each calculated defining value, information about the current motion is obtained and the corresponding control signal of the motion is output.

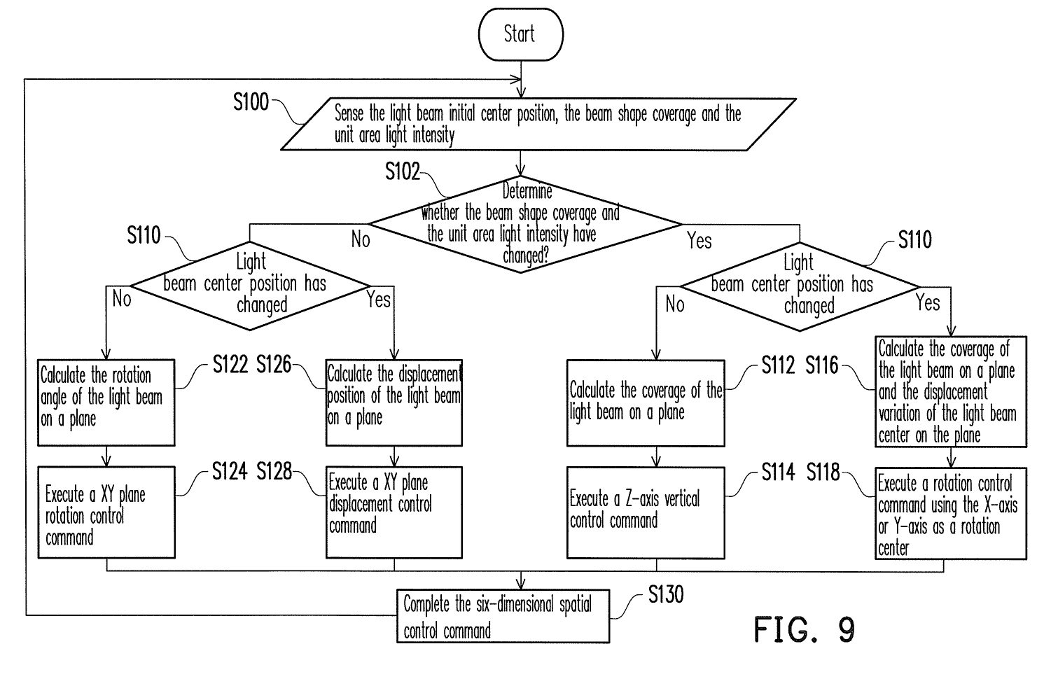

Thereafter, the process flow in the controlling of the entire multi-dimensional optical control device is discussed hereinafter. FIG. 9 is a flow chart of steps in an exemplary process that may be used in the controlling of the multi-dimensional optical control device according to one embodiment of the present invention.

In step S100, the initial center position of the light spot formed by the light beam on the sensor, the coverage of the light pattern, the unit area light intensity are sensed. The initial center position, the light spot shape coverage and the unit area light intensity are used as reference light spot. In essence, as the movable light source 101 and the lens 102 are at the initial positions, the center position of the light spot 106, the light pattern coverage and the unit area light intensity that are sensed by the sensor 104 are set as predetermined values (or the initial defining values), and these initial defining values are input to the data processing circuit 105.

Thereafter, in step S102, whether the detected light spot shape coverage or the unit area light intensity has changed is determined. In other words, when the movable light source 101 and the lens 102 commence a motion in space in six dimensions, the light pattern coverage of the light spot 106 and the unit area light intensity sensed by the sensor 104 are sent to the data processing circuit 105. Whether changes have been generated is calculated by the data processing circuit 105 and signals of the changed data are stored in the data processing circuit 105.

When the pixels on the sensor 104 sense no changes in the light coverage of the light spot 106 and the unit area light intensity, step S120 is performed, in which whether a change in the center position of the light spot 106 is determined.

When the center position of the light spot 106 changes, it implies that the light spot on the sensor 104 undergo a translational movement, as described in FIG. 3 above. Hence, the data processing circuit 105 in step S126 calculates the degree of movement of the center position of the light spot on the XY plane. Then, in step S128, a control signal is output, and in step S130, the execution of the translational movement control on the XY plane is completed.

On the other hands, in step S120, when the center position of the light spot 106 remain unchanged, it represents that the light spot on the sensor 104 undergo a rotational movement along the Z axis, as described in FIGS. 4A, 4B above. Then, step S122 is performed, in which the data processing circuit 105 calculates the rotation angle of the light spot along the Z-axis. Thereafter, in step S124, a control signal is output, and in step S130, the execution of the rotational movement control along the Z-axis is completed.

Moreover, in step S102, when the data processing circuit 105 determines the concurrent changes in the light spot coverage and the unit area light intensity of the light spot 106 sensed by the pixels on the sensor 104, step S110 is performed to determine whether the center position of the light spot 106 has changed.

When the center position of the light spot 106 changes, it is the rotation along the X-axis or Y-axis as discussed in the above FIG. 5A, 5B or 6A, 6B. Then, the data processing circuit 105 calculates in step S116 the light pattern coverage and the amount of the translational movement of the light spot center position. Thereafter, in step S118, the light pattern coverage and the amount of translational movement of light spot center position are calculated by the data processing circuit 105 and a control signal is output. Then, step S130 is executed to complete the rotational control using the X-axis or the Y-axis as the center of rotation.

On the other hand, during the execution of step S110, when there is no change in the center position of the light spot 106, this implies an up-and-down movement along the Z-axis as described in FIGS. 8A and 8D. The data processing circuit 105 calculates the light pattern coverage of the light spot in step S112. Then, in step S114, based on the light pattern coverage calculated by the data processing circuit 105, a control signal is output. Then, step S130 is executed to complete the vertical movement control along the Z-axis.

In accordance to the above, the analog or digital signals regarding the changes in the six dimensions are output through the data processing circuit 105, and the function of space control by the six-dimensional optical control device is hereby completed.

Within a fixed time period, the more changes in the pixels of the light spot sensed by the sensor 104, the faster the motion of the movable light source 101 and the lens 102 with respect to the sensor 104. After the calculation by the data processing circuit 105, a six-dimensional space control signal at an accelerated rate is output. On the other hand, when there are fewer changes in the pixels of the light spot sensed by the sensor 104 within a fixed time period, the slower the motion of the movable light source 101 and the lens 102 with respect to the sensor 104. Then, after the calculation by the data processing circuit 105, a six-dimensional space control signal at a decelerated rate is output.

According to the six-dimensional optical control device 100 of the embodiment of the present invention, using the above simple components and detection method, the six-dimensional precise control function of the horizontal and vertical direction movements and the three dimension rotational movements can be achieved.

It should be appreciated that this invention maybe embodied in many different forms and should not be construed as limited to the embodiments set forth above. The following embodiments are to describe variations of this invention.

According to the above embodiments, the shape of the light beams has not been reshaped; in other words, the light beam emits from the movable light source 101 and directly focuses on the sensing surface of the sensor 104 through the lens 102. Generally speaking, the light spot formed on the sensor surface appear to have an oval shape with a length-width ratio of not equal to 1. This shape is beneficial in determining whether the light spot have been rotated. The shape of the light spot affects the sensitivity in the determination of the changes generated in the light spot. Hence, the resolution in the control of the optical control device is also affected to a certain extent.

Accordingly, in order to further enhance the resolution in the control of the optical control device, the shape of the light beam can be reshaped. The method of reshaping a light beam includes, for example, adding a beam shaping device, for example, using a plate with holes. Commercially available beam-shaping devices that can provide the following functions can be applied as long as these devices do not affect the effects of the embodiment of the present invention.

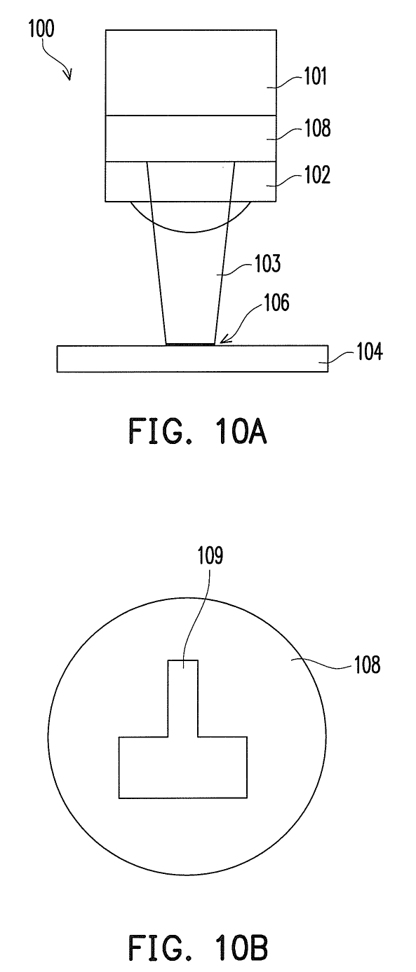

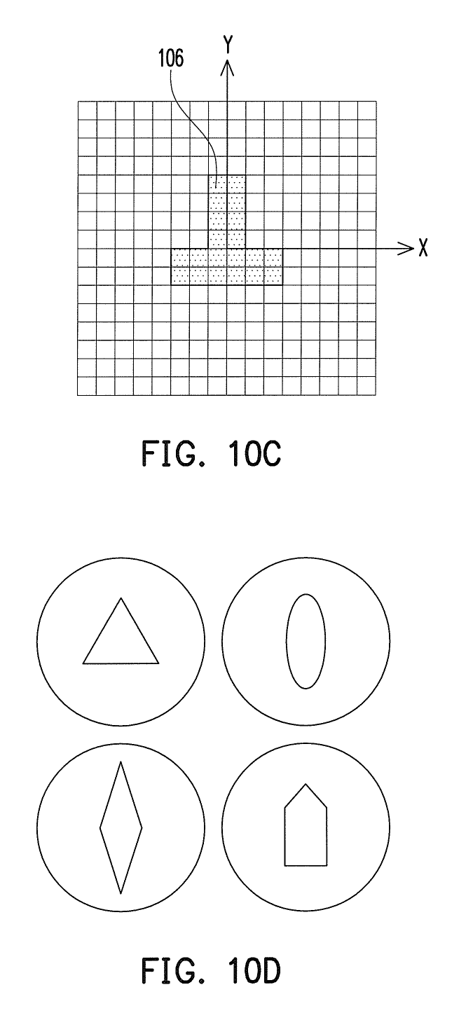

FIG. 10A is a schematic diagram of a multi-dimensional optical control device according to another embodiment of the present invention. FIGS. 10B, 10C, 10D are schematic diagrams of the plate in FIG. 10A. As shown in FIG. 10A, a plate 108 is added between the movable light source 101 and the lens 102, wherein the plate has a hole 109, and this hole 109 is directional hole. As exemplified in FIG. 10b, the hole 109 has a T-shape, for example.

After a light beam 103 reaches the plate 108, a portion of the light beam is blocked, while another portion of the light beam passes through the directional hole 109. Further passing through the lens, a light beam with a directional shape, for example, a cone shape, is resulted and is focused on the sensing surface of the senor 104. As shown in FIG. 10C, the shape of the light spot 106 is similar to the directional hole 109 of the plate 108. Through this beam reshaping method, the shape of the light spot 106 formed on the sensor 104 can be more precise to increase the control resolution.

FIG. 10D further illustrates other types of directional hole, for example, a hole in the shape of a triangle, ellipse, rhombus, or other types of polygon, etc., which are just few examples and are not to be construed as limiting the scope of the invention. In general, if a circular shape is used, a reference point must be added to the previous embodiments. When the light spot is a circle, the length-width ratio is 1 and is symmetrical at the X-axis and Y-axis. When a rotation is generated, it is unable to determine whether the spot has been rotated and an erroneous judgment of the motion is resulted. Hence, during a practical application, a perfect circle is not used. However, if a circular light spot or a circular hole is used, a pixel on the sensor 104 must be defined as a reference point to form a straight line connecting the light spot 106 and the reference point. When a rotational motion along the Z-axis is generated, the light spot is rotated with respect to the reference point. Accordingly, the positional changes due to a rotational motion of the circular light spot are determined.

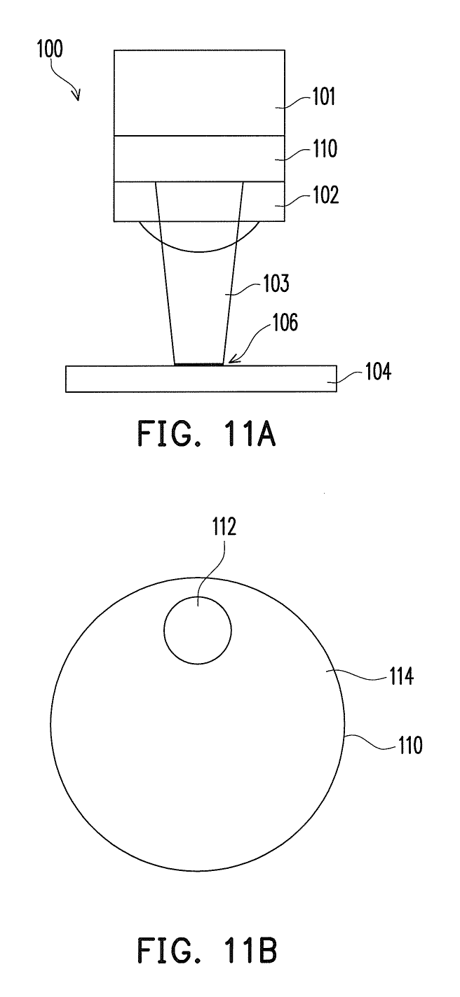

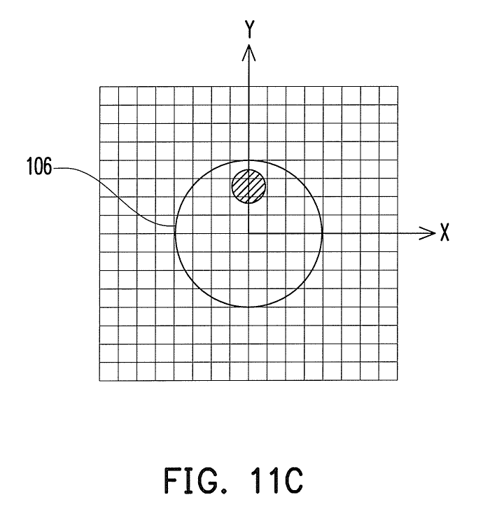

In the embodiment as illustrated in the above FIGS. 10A to 10D, the plate 108 an opaque material. However, a transparent material can also be used. FIG. 11A is a schematic diagram illustrating a multi-dimensional optical control device according to another embodiment of the present invention. As shown in FIG. 11, in this embodiment, which is similar to the embodiment as illustrated in FIG. 10A, a plate 110 is added between the movable light source 101 and the lens 102, and the only difference is that the plate 110 can be a transparent material. Based on the difference in light transmittance, the light intensity of the light beam 103 can be controlled. Moreover, FIG. 11B illustrates another example of the plate 110, wherein the plate 110 has two transparent regions 112 and 114 with different light transmittances. When the light beam 103 passes through the plate 110, there is an obvious high-low distribution in the light intensity. Further passing through the lens 102, a light beam having a high-low light intensity distribution and a cone shape is formed, which then illuminates on the sensor 104 to form a light spot 106 with a different light intensity distribution. In this embodiment, the plate 110 creates two regions with different light intensity distributions. However, in an actual practice, two more regions can be created. The appropriate design modification is performed depending on the actual requirements. In this embodiment, a circle is used as an example; however, different shapes can be formed. With multiple regions, the shape of each region can be the same or different, and there is not particular limitation.

Besides using different light transmittances to form regions with different light intensity distributions, different colors are applied to regions 112 and 114 in FIG. 11B to achieve different light transmittances.

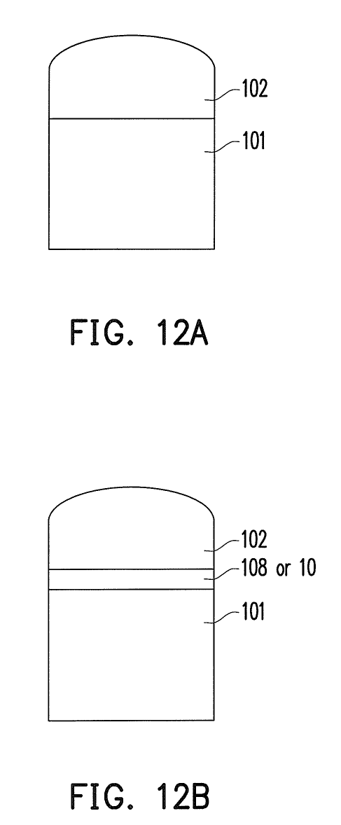

FIG. 12A is a schematic diagram showing the packaging structure of the light source and the lens. FIG. 12B is a schematic diagram illustrating the packaging structure of the light source, the plate and the lens. Since a typical light source, for example, a light source with multiple or single wave length, such as LED or LD, relies on packaging to protect and anchor the light source itself, the light source 101 and the lens 102 in the above embodiments are integrally combined as one entity by means of packaging as shown in FIG. 12A. Further, as shown in FIG. 12B, in the embodiments that include a transparent plate and opaque plate, the light source 101, the plate 108 (or plate 110) and the lens 102 can be integrally combined to form a light emitting device.

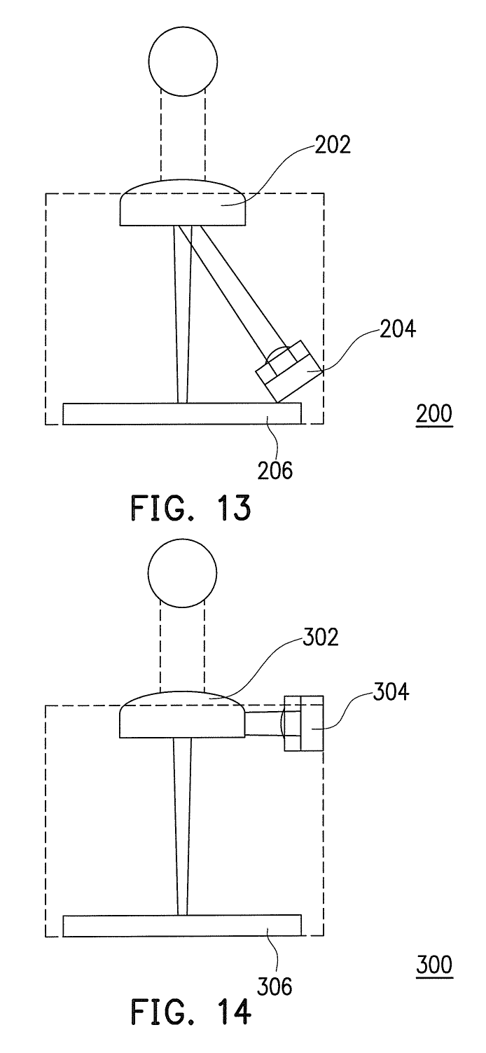

FIGS. 13 and 14 are varying examples of the embodiments of the present invention. As discussed above in the various embodiments, the light source can be designed as movable. In other words, by connecting with a movable structure, such as a control bar, to generate a corresponding movement or rotational control. However, the light source can be designed to be stationary, which is illustrated in the following examples.

As shown in FIGS. 13 and 14, the multi-dimensional optical control device 200 (300) includes a fixed light emitting device 204 (304) comprising a light source and a lens, a reflective element 202 (302), a sensor 206 (306) and a data processing circuit (not shown). In this embodiment, the light emitting device 204 (304) is fixed inside the multi-dimensional optical control device 200 (300) at any position that does not interfere with any motion of the sensor 206 (306) and can emit and focus a light beam. The reflective element 202 (302) is basically a movable element, which can be connected to control bar type of movable structure to achieve the moving and the rotating purposes. The reflective element 202 (302) can reflect the emitted light beam from the light emitting device 204 (304) to the sensor 206 (306). The reflective element 202 (302), through the movement or rotation of the movable structure, the light spot focused on the surface of the sensor 206 (306) generate a center position, a shape coverage or a unit area light intensity variation to generate the corresponding control signals.

The calculation and the disclosure of the center position variation, the shape coverage variation or the unit area light intensity variation generated by the light spot can be referred to the above embodiments and will not be further reiterated. The relationship between the data processing circuit and the sensor and the operation thereof are also similar to the above embodiments. Moreover, with regards to the plate, the material of the plate and the directional hole, etc. of the light emitting device can also be accomplished according to the above embodiments and will not be further reiterated.

According to the multi-dimensional optical control device of the embodiments of the invention, the light source can directly illuminate on the sensor, and a reflective surface is not required. Hence, the problem with a reflective surface having poor light reflectance can be prevented. Moreover, through simple optical structure and without increasing the number of components and structural volume, the input of the horizontal and vertical direction and six-dimensional control function is accomplished.

Moreover, the present invention uses a light source to directly illuminate on a sensor, without having to pass through a slit plate or a screen. The problems regarding consumption and the positioning of elements are greatly reduced. Through the detection of the changes in the pixel position, the range and the light intensity of the light source sensed by the sensor, a highly precise six-dimensional input control function can be achieved.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A multi-dimensional optical control device, comprising:
a movable light source, moved under an external control to generate a light beam;
a lens, coupled with the movable light source to focus the light beam;
a sensor, used in sensing a light spot focused on the sensor; and
a data process circuit, coupled to the sensor and used to obtain a position variation, a shape variation and a light intensity variation of the light spot on the sensor, wherein the position variation, the shape variation, and the light intensity variation correspond to a position, a shape or a light intensity of a reference light spot, and a control signal for performing a multi-dimensional control motion of a rotation or a movement is output based on the position variation, the shape variation or the light intensity variation.

2. The multi-dimensional optical control device according to claim 1, wherein the position variation comprises a rotation variation or a translation variation.

3. The multi-dimensional optical control device according to claim 1, wherein the shape variation comprises a variation generated due to a vertical movement or a rotational movement of the movable light source with respect to the sensor.

4. The multi-dimensional optical control device according to claim 1, wherein the movable light source comprises a single wave length light source.

5. The multi-dimensional optical control device of claim 4, wherein the single wave length light source comprises a laser diode.

6. The multi-dimensional optical control device according to claim 1, wherein the movable light source comprises a multi-wavelength light source.

7. The multi-dimensional optical control device according to claim 6, wherein the multi-wavelength light source is an incandescent lamp or a light emitting diode (LED).

8. The multi-dimensional optical control device according to claim 1, wherein the sensor comprises a two-dimensional plane sensor.

9. The multi-dimensional optical control device according to claim 8, wherein the two-dimensional plane sensor comprises at least one of a PD array sensor, a CMOS sensor and a CCD sensor.

10. The multi-dimensional optical control device according to claim 1, wherein the control signal is a digital signal or an analog signal.

11. The multi-dimensional optical control device according to claim 1, wherein the movable light source and the lens are integrally packaged together.

12. The multi-dimensional optical control device according to claim 1 comprising a beam shaping device, positioned between the movable light source and the lens and used to reshape the light beam emitted from the movable light source.

13. The multi-dimensional optical control device according to claim 12, wherein the beam shaping device comprises a plate, and the plate comprises a hole for allowing the light beam to pass through.

14. The multi-dimensional optical control device according to claim 13, wherein the plate is opaque.

15. The multi-dimensional optical control device according to claim 14, wherein the hole does not have a circular shape.

16. The multi-dimensional optical control device according to claim 14, wherein the hole has a circular shape and moves with respect to the reference point on the sensor.

17. The multi-dimensional optical control device according to claim 12, the light beam shaping device is a plate, and the plate is transparent.

18. The multi-dimensional optical control device according to claim 17, wherein the plate comprises at least two regions with different transmittances.

19. The multi-dimensional optical control device according to claim 17, wherein the plate comprises two regions with different colors.

20. The multi-dimensional optical control device according to claim 12, wherein the movable light source, the light beam shaping device and the lens are packaged integrally.

21. A multi-dimensional optical control device, comprising:
a fixed light source, used for generating a light beam;
a lens, coupled with the fixed light source for focusing the light beam;
a movable reflective device, moved under an external control for reflecting the light beam focused by the lens;
a sensor for sensing a light spot formed on the sensor by the reflected light beam;
a data processing circuit, coupled to the sensor and used in obtaining a position variation, a shape variation or a light intensity change quantity of the light spot on the sensor, wherein the position variation, the shape variation, and the light intensity variation correspond to a position, a shape or a light intensity of a reference light spot, and a control signal for performing a multi-dimensional control motion of a rotation or a movement is output based on the position variation, the shape variation or the light intensity variation.

22. The multi-dimensional optical control device according to claim 21, wherein the position variation comprises a rotational variation or a translational variation.

23. The multi-dimensional optical control device according to claim 21, wherein the shape variation comprises a variation generated due to a vertical movement or a rotational movement of the movable light source with respect to the sensor.

24. The multi-dimensional optical control device according to claim 21, wherein the movable light source comprises a single wave length light source.

25. The multi-dimensional optical control device of claim 24, wherein the single wave length light source comprises a laser diode.

26. The multi-dimensional optical control device according to claim 21, wherein the movable light source comprises a multi-wavelength light source.

27. The multi-dimensional optical control device according to claim 26, wherein the multi-wavelength light source is an incandescent lamp or a light emitting diode (LED).

28. The multi-dimensional optical control device according to claim 21, wherein the sensor comprises a two dimensional plane sensor.

29. The multi-dimensional optical control device according to claim 28, wherein the two-dimensional plane sensor comprises at least one of a PD array sensor, a CMOS sensor and a CCD sensor.

30. The multi-dimensional optical control device according to claim 21, wherein the control signal is a digital signal or an analog signal.

31. The multi-dimensional optical control device according to claim 21, wherein the movable light source and the lens are integrally packaged together.

32. The multi-dimensional optical control device according to claim 1 comprising a beam shaping device, positioned between the movable light source and the lens and used to reshape the light beam emitted from the movable light source.

33. The multi-dimensional optical control device according to claim 32, wherein the beam shaping device comprises a plate, and the plate comprises a hole for the light beam to pass through.

34. The multi-dimensional optical control device according to claim 33, wherein the plate is opaque.

35. The multi-dimensional optical control device according to claim 34, wherein the hole does not have a circular shape.

36. The multi-dimensional optical control device according to claim 34, wherein the hole has a circular shape and moves with respect to the reference point on the sensor.

37. The multi-dimensional optical control device according to claim 32, the light beam shaping device is a plate, and the plate is transparent.

38. The multi-dimensional optical control device according to claim 37, wherein the plate comprises at least two regions with different transmittances.

39. The multi-dimensional optical control device according to claim 37, wherein the plate comprises two regions with different colors.

40. The multi-dimensional optical control device according to claim 32, wherein the movable light source, the light beam shaping device and the lens are packaged integrally.

41. A multi-dimensional optical control method, for performing a multi-dimensional movement control according a change of a light spot sensed by a sensor, the multi-dimensional optical control method comprising:
setting an initial defining value of a reference light spot, the initial defining value comprising an initial center position, an initial light spot shape coverage and an initial unit area light intensity;
determining whether a light spot shape coverage and an unit area light intensity of the light spot have changed after the light spot generates a movement;
generating a control signal for executing a multi-dimensional movement control according to a light spot shape coverage variation and a light intensity variation.

42. The multi-dimensional optical control method of claim 41, wherein the light spot shape coverage variation and the light intensity variation are zero, the method further comprising:
determining whether a center position of the light spot has displaced from the initial position of the reference spot after the movement;
calculating a translational movement quantity of the center position with respect to the initial center position when the center position has displaced for executing a translational movement with respect to a plane of the sensor; and
calculating a rotational angle of the light pattern coverage with respect to the initial light pattern coverage to execute a rotational movement vertical to the plane of the sensor.

43. The multi-dimensional optical control method of claim 41, wherein when the light pattern coverage variation and the light intensity variation are not zero, the method further comprising:
determining whether a center position of the light spot has displaced from the initial position of the reference spot after the movement;
when the center position has been displaced, calculating a translational movement variation of the center position with respect to the initial center position and a variation of the light spot shape coverage with respect to the initial light spot shape distribution range for executing a rotational movement parallel to a plane of the sensor; and
when the center position has not been displaced, calculating a variation of the light spot coverage with respect to the initial light spot coverage for executing a vertically translational movement vertical to the sensor.

44. The multi-dimensional optical control method of claim 41 further comprising:
outputting an accelerated control signal or a decelerated control signal within a predetermined time period according to a sensed pixel variation of the light spot.

45. The multi-dimensional optical control method of claim 41, wherein the initial defining value of the reference light spot is used as a standard of the center position of the sensor.
